(19) United States
(12) Patent Application Publication
(10) Pub. No.: US 2013/0029214 A1
(43) Pub. Date: Jan. 31, 2013

(54) LAMINATE-CASED BATTERY WITH TABS PARTIALLY EXTENDING OUTWARDLY ACROSS SEALED PORTION OF LAMINATE CASE

(71) Applicant: Hitoshi Tamura, Sayama-shi (JP)

(72) Inventor: Hitoshi Tamura, Sayama-shi (JP)

(73) Assignee: SANYO ELECTRIC CO., LTD., Osaka (JP)

(21) Appl. No.: 13/558,832

(22) Filed: Jul. 26, 2012

(30) Foreign Application Priority Data
Jul. 26, 2011 (JP) 2011-162803

(51) Int. Cl. H01M 2/02; H01M 2/30

(52) U.S. Cl. 429/179

(57) ABSTRACT

A laminate-cased battery comprises: an electrode assembly; a laminate case having a sealed portion; a positive tab; and a negative tab. In at least one of crossing areas of the sealed portion that the positive tab and the negative tab cross, a distance between outer surfaces of the laminate case in a thickness direction of the corresponding tab, which is one of the positive tab and the negative tab, is smaller in a first portion of the crossing area than in a second portion thereof, the first portion being located closer to a tip portion of the corresponding tab in an extending direction thereof, and the second portion being located closer to a root portion of the corresponding tab in the extending direction.

### TECHNICAL FIELD

The present invention relates to a laminate-cased battery, and in particular to the structure of a laminate case at an extending portion of a tab.

### BACKGROUND ART

Along with the popularization of mobile apparatuses, laminate-cased batteries that each have a laminate case made of a metal laminate sheet have been prevalent. Such a laminate-cased battery has an electrode assembly housed in a laminate case. The electrode assembly is formed with a positive plate, a negative plate, and a separator which is inserted between the positive plate and the negative plate. The laminate case is formed by pressing and bending a metal laminate sheet.

The positive plate of the electrode assembly is connected to a positive tab, whereas the negative plate thereof is connected to a negative tab. The positive tab and the negative tab extend outwardly across a part of a sealed portion, which is formed by sealing an outer edge of the laminate case. The following describes a conventional structure of an area of the sealed portion of the laminate case that the negative tab crosses, with reference to FIG. 1.

As shown in FIG. 1, a laminate case 920 is formed with an aluminum (Al) layer 921, and resin layers 922 and 923. One of the main surfaces of the aluminum layer 921 is covered with the resin layer 922, and the other with the resin layer 923. A positive plate and a negative plate of an electrode assembly 910 are connected to a positive tab and a negative tab 915, respectively. Tab resin 932 is provided in respective areas of the sealed portion of the laminate case 920 that the positive tab and the negative tab 915 cross. Specifically, the tab resin 932 is provided between the positive tab and the resin layer 922, which is an inner layer of the laminate case 920, and between the resin layer 922 and the negative tab 915. The tab resin 932 is provided to ensure the sealing properties at the respective areas of the sealed portion that the positive tab and the negative tab 915 cross, and is made of polyethylene naphthalate layer (PEN), for example.

Also, the laminate case 920 has blisters (outer surfaces 920f₁ and 920f₂) in the areas of the sealed portion that the positive tab and the negative tab 915 cross. The blisters are provided so that the positive tab and the negative tab 915 escape in their thickness directions and are received by the blisters. This prevents direct contact between the Al layer 921 of the laminate case 920 and each of the positive tab and the negative tab 915 during heat-sealing.

### CITATION LIST

### Patent Literature

### Patent Literature 1

### Japanese Patent Application Publication No. 2000-348695

### SUMMARY OF INVENTION

### Technical Problem

However, the laminate-cased battery according to the conventional technique has a problem of low sealing reliability in at least one of areas of the sealed portion of the laminate case 920 that the tabs cross. The present inventors studied on the cause of this problem, and found that the thickness of the sealed portion varies in at least one of the areas of the sealed portion that the tabs cross. Specifically, in the at least one of the areas, the thickness varies in a portion closer to the root portion of the corresponding tab extending from the electrode assembly 910, i.e., in a portion closer to the housing space (the portion shown by the arrow C in FIG. 1), and that the variation in thickness results in low sealing reliability.

A laminate-cased battery having such low sealing reliability is likely to have poor battery performance, and thus requires improvement.

The present invention has been achieved in view of the above problem, and an aim thereof is to provide a laminate-cased battery having high sealing reliability in at least one of areas of a sealed portion of a laminate case that tabs cross, and having stable quality.

### Solution to Problem

In order to solve the above problem, the present invention has the following structure.

The present invention provides a laminate-cased battery comprising: an electrode assembly; a laminate case; a positive tab; and a negative tab.

The electrode assembly includes a positive plate and a negative plate.

The laminate case houses the electrode assembly therein. The laminate case is made of a metal laminate sheet including a metal layer and a resin layer that are laminated on each other, and has a sealed portion which is a sealed edge of the metal laminate sheet.

The positive tab is made of a conductive material and connected to the positive plate. The negative tab is made of a conductive material and connected to the negative plate. Each of the positive tab and the negative tab crosses the sealed portion and partially extends outwardly from the laminate case.

Regarding the laminate-cased battery according to the present invention, in at least one of crossing areas of the sealed portion that the positive tab and the negative tab cross, a distance between outer surfaces of the laminate case in a thickness direction of the corresponding tab, which is one of the positive tab and the negative tab, is smaller in a first portion of the crossing area than in a second portion thereof. Here, the first portion is located closer to a tip portion of the corresponding tab in an extending direction thereof, and the second portion is located closer to a root portion of the corresponding tab in the extending direction.

### Advantageous Effects of Invention

The laminate-cased battery according to the present invention has the following structure. That is, in at least one of the crossing areas of the sealed portion that the positive tab and the negative tab cross, the distance between the outer surfaces of the laminate case in the thickness direction of the corresponding tab is smaller in the first portion of the crossing area than in the second portion thereof.

The first portion is located closer to the tip portion of the corresponding tab in the extending direction thereof, and the second portion is located closer to the root portion of the corresponding tab in the extending direction. This structure alleviates the stress of the corresponding tab in a portion closer to the root portion as compared to a portion closer to the tip portion, in the at least one of the crossing areas. As a result, the thickness of the sealed portion is substantially equalized in the second portion of the at least one of the crossing areas, whereby a decrease in sealing reliability is suppressed.

Accordingly, the laminate-cased battery according to the present invention has high sealing reliability in the at least one of the crossing areas of the sealed portion of the laminate case, and has stable quality.

The laminate-cased battery according to the present invention may be modified to include the following variations, for example.

Regarding the laminate-cased battery according to the present invention, in the at least one of the crossing areas, the distance between the outer surfaces of the laminate case may gradually decrease from the second portion to the first portion.

This allows a surface of the at least one of the crossing areas to be even without any steps, and realizes a smooth change in the distance between the outer surfaces of the laminate case. This makes it possible to obtain even higher sealing reliability.

Regarding the laminate-cased battery according to the present invention, in the at least one of the crossing areas, a taper angle formed between the outer surfaces of the laminate case as the distance between the outer surfaces gradually decreases is from 1° to 3° inclusive.

Regarding the laminate-cased battery according to the present invention, the negative tab may be thicker than the positive tab, and the distance between the outer surfaces of the laminate case may be smaller in the first portion than in the second portion of the crossing area that the negative tab crosses.

According to the structure of the conventional laminate-cased battery, the stress of the negative tab is high in a portion closer to the root portion in the crossing area during the sealing process. This is because the negative tab is relatively thicker than the positive tab. In such a case, the aforementioned structure according to the present invention may be applied to the crossing area of the sealing portion of the laminate case that the negative tab crosses. This reliably improves the sealing reliability of the crossing area that the negative tab crosses. As a result, reliability of the laminate-cased battery as a whole is improved.

Regarding the laminate-cased battery according to the present invention, the resin layer of the laminate case may be disposed inward with respect to the metal layer. Also, in the at least one of the crossing areas where the distance between the outer surfaces of the laminate case is smaller in the first portion than in the second portion, a compression ratio of the resin layer may be lower in the second portion than in the first portion. The stated structure alleviates the stress of the corresponding tab in a portion closer to the root portion in the crossing area, thus improving sealing reliability.

Regarding the laminate-cased battery according to the present invention, in the crossing areas of the sealed portion that the positive tab and the negative tab cross, a resin sheet may be provided between the positive tab and the laminate case and between the negative tab and the laminate case, the resin sheet being made of a resin material different from a resin material of the resin layer. Also, in the at least one of the crossing areas where the distance between the outer surfaces of the laminate case is smaller in the first portion than in the second portion, a compression ratio of the resin sheet may be lower in the second portion than in the first portion. This alleviates the stress of the corresponding tab in the portion closer to the root portion in the crossing area. As a result, sealing reliability is further improved.

Regarding the laminate-cased battery according to the present invention, the resin layer of the laminate case may be disposed inward with respect to the metal layer. Also, in the crossing areas of the sealed portion that the positive tab and the negative tab cross, both surfaces of each of the positive tab and the negative tab in a thickness direction thereof may be densely covered with the resin layer. This makes it possible to obtain even higher sealing reliability.

### BRIEF DESCRIPTION OF DRAWINGS

FIG. 1 is a schematic sectional view showing the structure of a laminate-cased battery according to a conventional technique, particularly the structure of an extending portion of a negative tab 915.

FIG. 2 is a schematic perspective view (partially cutaway view) showing the structure of a laminate-cased battery 1 according to an embodiment of the present invention.

FIG. 3 is a schematic sectional view showing the structure of an extending portion of a negative tab 15 in the laminate-cased battery 1.

FIG. 4A schematically shows a part of a manufacturing process of the laminate-cased battery 1.

FIG. 4B schematically shows a part of the manufacturing process of the laminate-cased battery 1.

FIG. 5A schematically shows a part of the step of sealing a periphery of the extending portion of the negative tab 15, in the manufacturing process of the laminate-cased battery 1.

FIG. 5B schematically shows a part of the step of sealing the periphery of the extending portion of the negative tab 15, in the manufacturing process of the laminate-cased battery 1.

FIG. 6 is a characteristic chart relating to laminate-cased batteries according to an embodiment example and a comparative example, the characteristic chart showing a relationship between a storage period and a battery expansion.

FIG. 7A is a schematic sectional view showing the structure of laminate forming dies 521 and 522, which are used to manufacture a laminate-cased battery according to Modification 1.

FIG. 7B is a schematic sectional view showing the structure of a laminate forming die 531, which is used to manufacture a laminate-cased battery according to Modification 2.

FIG. 7C is a schematic sectional view showing the structure of a laminate forming die 541, which is used to manufacture a laminate-cased battery according to Modification 3.

### DESCRIPTION OF EMBODIMENT

The following describes an embodiment of the present invention, with reference to the drawings. Note that a specific example given below is used to clearly describe the structure and advantageous effects of the present invention. The present invention is not limited to the specific example given below, except the essential components of the present invention.

### Embodiment

### 1. Overall Structure

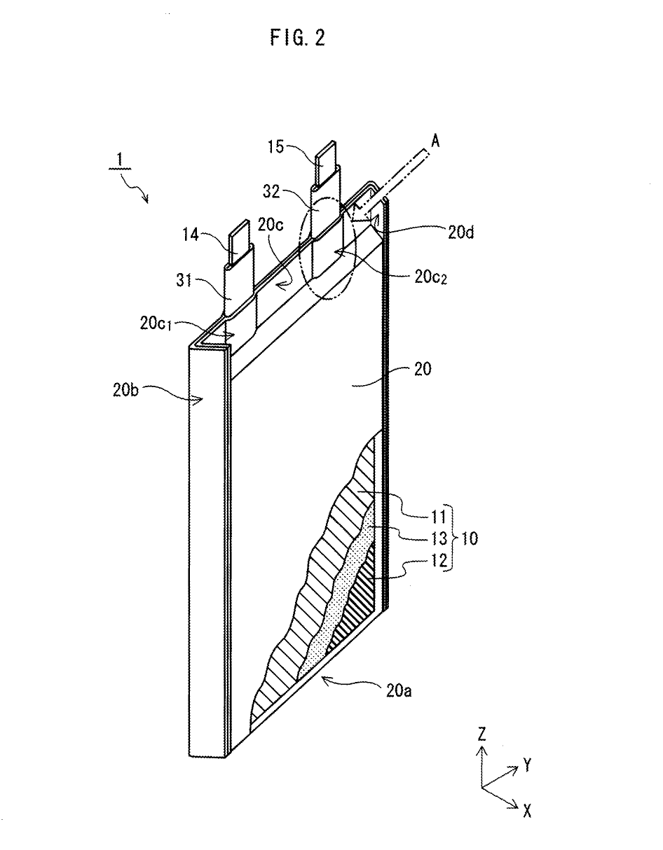

The following describes the structure of a laminate-cased battery 1 according to the present embodiment, with reference to FIG. 2.

As shown in FIG. 2, the laminate-cased battery 1 includes an electrode assembly 10 and a laminate case 20 made of a metal laminate sheet. The electrode assembly 10 is composed of a positive plate 11, a negative plate 12, and a separator 13, and is housed in a space (housing space) inside the laminate case 20. Regarding the laminate-cased battery 1 according to the present embodiment, the electrode assembly 10 has a winding body which is formed as follows. First, the positive plate 11 and the negative plate 12 are disposed to face each other with the separator 13 therebetween. Then, the positive plate 11, the negative plate 12, and the separator 13 are spirally wound in that state.

The positive plate 11 of the electrode assembly 10 is made of aluminum foil to which lithium cobalt oxide (LiCoO₂) is applied. The negative plate 12 is made of copper foil to which graphite powder is applied. Also, the separator 13 is made of, for example, porous polyethylene having a thickness of 0.03 mm.

Although not shown in FIG. 2, the electrode assembly 10 housed in the housing space of the laminate case 20 is impregnated with polymer electrolyte. Regarding the laminate-cased battery 1 according to the present embodiment, the polymer electrolyte may be prepared as follows, for example. First, polyethylene glycol diacrylate is mixed with an EC/DEC mixture (mass ratio of 30:70) at 1:10 ratio. Then, 1 mol/L of LiPF₆ is added to the mixture, and gelatinized through thermal polymerization.

The laminate case 20 has a so-called three-side sealed structure. Specifically, the laminate case 20 is formed with one metal laminate sheet that has been pressed and bent. Three outer edges of the laminate case 20 are heat-sealed to form sealed portions 20b, 20c, and 20d, while a bottom portion 20a positioned at a lower end of the laminate case 20 in the z-axis direction is left unsealed.

The positive plate 11 of the electrode assembly 10 is connected to a positive tab 14, and the negative plate 12 is connected to a negative tab 15. The positive tab 14 and the negative tab 15 extend outwardly across the sealed portion 20c positioned at an upper end of the laminate case 20 in the Z-axis direction. Also, tab resin 31 is provided between the positive tab 14 and the inner surface of the laminate case 20, and tab resin 32 is provided between the negative tab 15 and the inner surface of the laminate case 20. This is to ensure the adhesive strength and increase the sealing properties, and to insulate the positive tab 14 and the negative tab 15 from the metal layer (Al layer) of the laminate case 20 exposed at edges of the laminate case 20.

Here, the positive tab 14 is made of aluminum (Al) or an aluminum alloy, for example. Also, the negative tab 15 is made of copper (Cu), nickel (Ni), or an alloy thereof. The negative tab 15 is thicker than the positive tab 14.

In the sealed portion 20c at the upper end of the laminate case 20 in the Z-axis direction, more specifically in the areas of the sealed portion 20c that the positive tab 14 and the negative tab 15 cross, blisters 20c₁ and 20c₂ are provided to allow the positive tab 14 and the negative tab 15 to escape in their thickness directions (X-axis direction). The blisters 20c₁ and 20c₂ are swollen outwardly so as to receive the positive tab 14 and the negative tab 15.

### 2. Structure of Area of Sealed Portion 20c that Negative Tab 15 Crosses

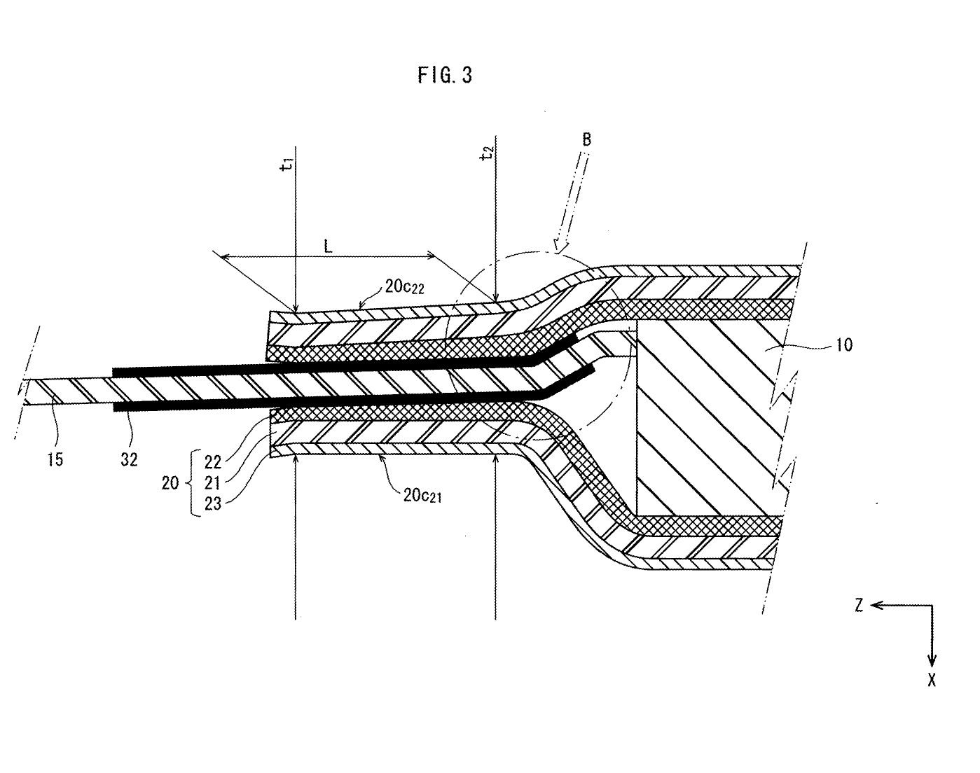

The following describes the structure of the area of the sealed portion 20c of the laminate case 20 that the negative tab 15 crosses, with reference to FIG. 3. FIG. 3 is a schematic sectional view showing the structure of the portion shown by the arrow A in FIG. 2.

As shown in FIG. 3, the laminate case 20 is formed with a metal layer (Al layer) 21, an inner resin layer 22 and an outer resin layer 23. One of the main surfaces of the Al layer 21 is covered with the inner resin layer 22 and the other with the outer resin layer 23. Note that although not shown in FIG. 3, the laminate case 20 further includes, for example, a dry laminate adhesive layer (bonding layer) having a thickness of approximately 5 μm, between the metal layer 21 and the outer resin layer 23.

In the area of the sealed portion 20c of the laminate case 20 that the negative tab 15 crosses, the tab resin 32 is provided between the negative tab 15 and the inner resin layer 22 of the laminate case 20. The tab resin 32 is made of polyethylene naphthalate (PEN), for example, and is provided for the purpose of ensuring excellent sealing properties and insulation properties.

Note that a root portion of the negative tab 15 in an extending direction thereof, which is a portion extending from the electrode assembly 10, is positioned offset from a tip portion of the negative tab 15 in an extending direction thereof, which is a portion extending outwardly from the laminate case 20, in a thickness direction of the electrode assembly 10 (X-axis direction). This means that as shown in FIG. 3, the negative tab 15 is bent between a root portion extending from the electrode assembly 10 and a portion close to the root portion in the area of the sealed portion 20c.

In the area of the sealed portion 20c of the laminate case 20 that the negative tab 15 crosses, a surface 20c₂₁ at a lower end of the laminate case 20 in the X-axis direction is horizontal along the Z axis. On the other hand, a surface 20c₂₂ at an upper end of the laminate case 20 in the X-axis direction is inclined upward in the X-axis direction, from left to right in the Z-axis direction. In other words, in the area of the sealed portion 20c of the laminate case 20 that the negative tab 15 crosses, the distance between the surface 20c₂₁ and the surface 20c₂₂ of the laminate case 20 is inconsistent. More specifically, a distance t₂ at a portion of the area located closer to the root portion of the negative tab 15 in the extending direction thereof is larger than a distance t₁ at a portion of the area located closer to the tip portion of the negative tab 15. This relationship is expressed by the following formula.

t₁<t₂ [Formula 1]

Also, regarding the laminate-cased battery 1 according to the present embodiment, the compression ratio of the inner resin layer 22 of the laminate case 20 and the compression ratio of the tab resin 32 are each inconsistent in the area of the sealed portion 20c of the laminate case 20 that the negative tab 15 crosses. Specifically, the compression ratios thereof are lower at the portion of the area located closer to the root portion of the negative tab 15 in the extending direction thereof than at the portion of the area located closer to the tip portion of the negative tab 15.

According to the present embodiment, the relationship expressed by the following formula is satisfied where the separation distance L in the Z-axis direction between the positions defining the distance t₁ and the positions defining the distance t₂.

1°≦tan⁻¹((t₂−t₁)/L)≦3° [Formula 2]

### 3. Effects

Regarding the laminate-cased battery 1 according to the present embodiment, in the area of the sealed portion 20c of the laminate case 20 that the negative tab 15 crosses, the distance t₂ at the portion of the area located closer to the root portion of the negative tab 15 in the extending direction thereof is larger than the distance t₁ at the portion of the area located closer to the tip portion of the negative tab 15, as shown in FIG. 3 (see [Formula 1]). This alleviates the stress of the negative tab 15 in a portion located closer to the root portion thereof in the extending direction (the portion shown by the arrow B in FIG. 3) as compared to a portion located closer to the tip portion thereof, in the area of the sealed portion 20c of the laminate case 20 that the negative tab 15 crosses.

Also, regarding the laminate-cased battery 1 according to the present embodiment, in the area of the sealed portion 20c of the laminate case 20 that the negative tab 15 crosses, the surface 20c₂₂ of the laminate case 20 has an inclination angle from 1° to 3° inclusive so as to satisfy the [Formula 2] above. As a result, the distance between the surface 20c₂₁ and the surface 20c₂₂ of the laminate case 20 gradually changes in the area of the sealed portion 20c of the laminate case 20 that the negative tab 15 crosses.

With the above structure, the laminate-cased battery 1 according to the present embodiment has high sealing reliability in the area of the sealed portion 20c of the laminate case 20 that the negative tab 15 crosses, and has stable quality.

Although not mentioned in the present embodiment, the structure shown in FIG. 3 may be applied to the area of the sealed portion 20c of the laminate case 20 that the positive tab 14 crosses. However, since the positive tab 14 is thinner than the negative tab 15, the stress of the positive tab 14 may not have an adverse effect on the sealing reliability. In this case, it is not necessary to apply the structure shown in FIG. 3 to the positive tab 14.

### 4. Manufacturing Method

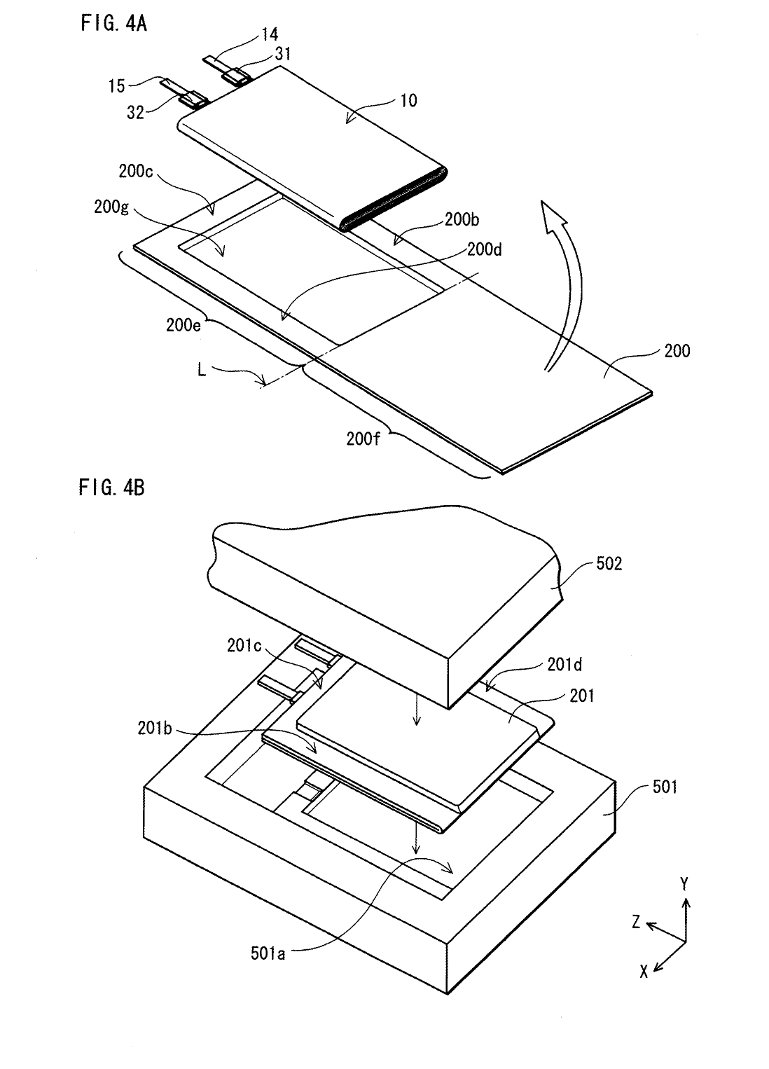

The following describes a manufacturing method of the laminate-cased battery 1 according to the present embodiment, with reference to FIG. 4A and FIG. 4B. Note that the following describes a part of the manufacturing process of the laminate-cased battery 1.

First, as shown in FIG. 4A, the positive tab 14 and the negative tab 15 are connected to the electrode assembly 10. Then, the tab resin 31 and the tab resin 32 are applied to cover the positive tab 14 and the negative tab 15, respectively.

Next, the electrode assembly 10 to which the positive tab 14, the negative tab 15, etc. are attached is housed in a cup-shaped recess 200 g of a metal laminate sheet 200. At this point, the tab resin 31 is sandwiched between the positive tab 14 and an outer edge 200c of the metal laminate sheet 200 which is located at an upper end thereof, and the tab resin 32 is sandwiched between the negative tab 15 and the outer edge 200c of the metal laminate sheet 200.

Next, the metal laminate sheet 200 is folded along a folding line L so that a main surface 200f faces a main surface 200e. In this way, the outer edges of the main surface 200f overlap outer edges 200b, 200c, and 200d of the main surface 200e, whereby the recess 200g is covered by the main surface 200f.

Next, as shown in FIG. 4B, a metal laminate sheet 201 which is bent with the electrode assembly 10 housed therein is placed inside a recess 501a of a laminate forming die 501, and pressed from above by a laminate forming die 502. Here, the areas of the laminate forming dies 501 and 502 corresponding to outer edges 201b, 201c, and 201d of the metal laminate sheet 201 have integrated heaters. With the integrated heaters, overlapped portions of the inner resin layer 22 of the metal laminate sheet 201, which correspond to the outer edges 201b, 201c, and 201d, adhere to each other.

In the areas of the metal laminate sheet 201 that the positive tab 14 and the negative tab 15 cross, the inner resin layer 22 of the metal laminate sheet 201 adheres to the tab resin 31 and the tab resin 32.

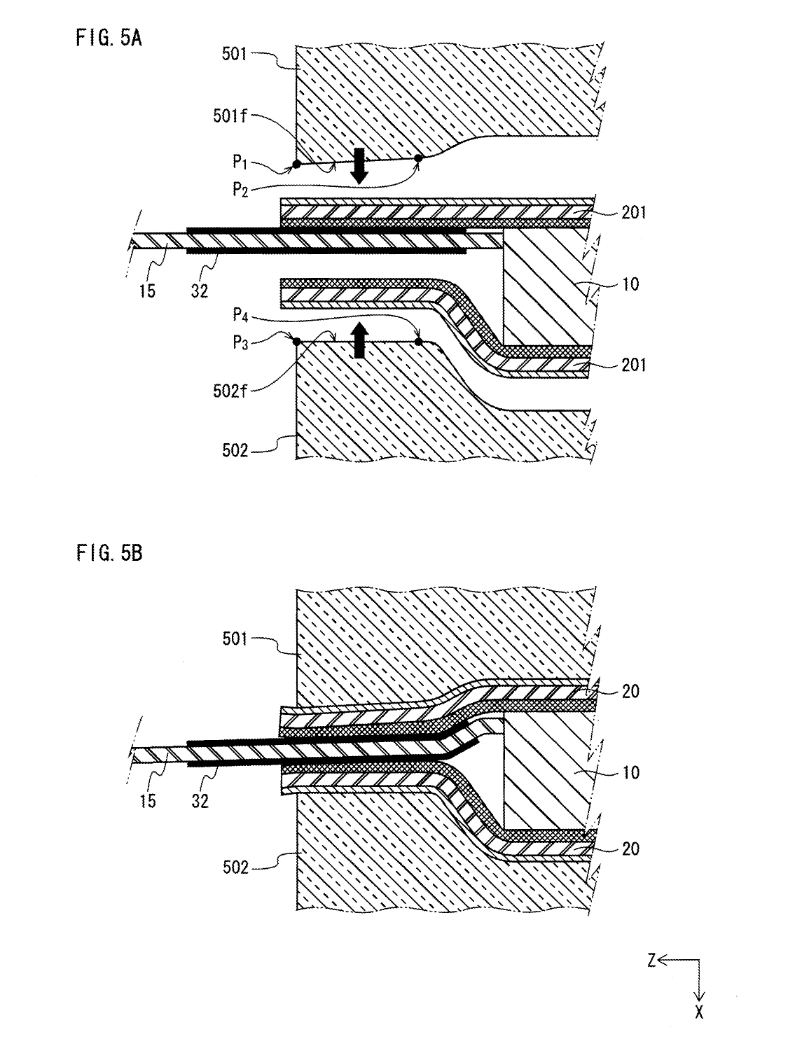

Regarding the laminate forming process shown in FIG. 4B, the following describes details of processing steps in an area of the sealed portion of the laminate case 201, with reference to FIGS. 5A and 5B. Specifically, the area of the sealed portion is where the negative tab 15 crosses, and the sealed portion is formed by sealing the outer edge 201c.

As shown in FIG. 5A, the negative tab 15 before press work is in the state of extending substantially straight along the Z axis. In this state, a portion of the metal laminate sheet 201 covering the upper end of the negative tab 15 in the X-axis direction is substantially in a flat plate shape.

A surface 502 f of the laminate forming die 502 corresponding to the sealed portion of the metal laminate sheet 201 is a horizontal surface parallel to the Z axis.

In other words, a point P₃ is positioned at the same height as a point P₄ in the X-axis direction.

On the other hand, a surface 501f of the laminate forming die 501 corresponding to the sealed portion of the metal laminate sheet 201 is not a horizontal surface parallel to the Z axis. Instead, the surface 501f is inclined upward in the X-axis direction, from left to right in the Z-axis direction. In other words, a point P₂ of the laminate forming die 501 is positioned more upward than a point P₁ thereof in the X-axis direction.

The laminate forming dies 501 and 502 arranged as shown in FIG. 5A are closed as shown in FIG. 5B. In this way, the laminate case 20 having the sealed portion 20c is obtained, as shown in FIG. 5B. The relationship between the negative tab 15 and the laminate case 20 is described above.

### 5. Confirmation of Effects

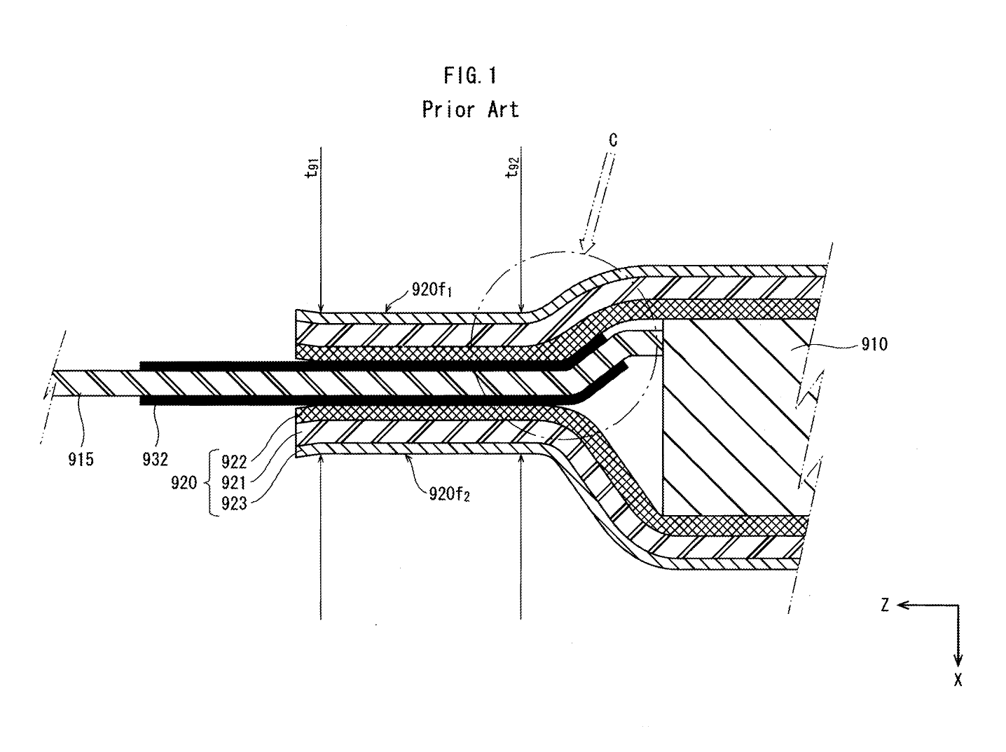

The following describes an experiment performed to confirm the aforementioned advantageous effects, with use of the laminate-cased battery 1 according to the present embodiment as an embodiment example and the conventional laminate-cased battery shown in FIG. 1 as a comparative example. The structures of the laminate-cased battery 1 and the conventional laminate-cased battery are described below.

### Embodiment Example

The structure of the area of the sealed portion 20c of the laminate case 20 that the negative tab 15 crosses is as shown in FIG. 3. Note that unlike the laminate-cased battery 1 according to the present embodiment, the area of the sealed portion 20c of the laminate case 20 that the positive tab 14 crosses also has the structure as shown in FIG. 3.

Dimensions of battery: height 110.0 mm×width 68.0 mm×thickness 3.7 mm

Width of sealed portion: 1.5 mm

Laminate case: from the outer surface of the battery, nylon (25 μm)/adhesive layer (3 μm)/aluminum layer (40 μm)/polypropylene layer (45 μm)

The inclination angle in [Formula 2] above is set to 2°.

### Comparative Example

The structure of the areas of the sealed portion of the laminate case 920 that the positive tab and the negative tab 915 cross is as shown in FIG. 1. The dimensions of the battery and the structure of the laminate case is the same as in the embodiment example above.

In the areas of the sealed portion that the positive tab and the negative tab 915 cross, specifically in portions of the respective areas located closer to the tip portions of the positive tab and the negative tab 915, the distance between the outer surfaces 920f₁ and 920f₂ satisfies the following relationship.

t₉₁=t₉₂ [Formula 3]

t₉₁≈t₁ [Formula 4]

Note that the batteries of the embodiment example and the comparative example have the same structure except for the area of the sealed portion of the laminate case 20 that the negative tab 15 crosses and the area of the sealed portion of the laminate case 920 that the negative tab 915 crosses.

### (1) Dimensions at Tab Crossing Area

Table 1 shows a result of measurement of the distances t₁ and t₂ at the tab crossing area of each of the samples (n=5) of the embodiment example and the distances t₉₁ and t₉₂ at the tab crossing area of each of the samples (n=5) of the comparative example.

TABLE 1

| | Comparative Example | | Embodiment example | |
|---|---|---|---|---|
| | t₉₁ [μm] | t₉₂ [μm] | t₁ [μm] | t₂ [μm] |
| Positive tab | 357 | 359 | 331 | 377 |
| side | | | | |
| Negative tab | 355 | 357 | 332 | 378 |
| side | | | | |

### (2) Effect under High Temperature and High Humidity Storage

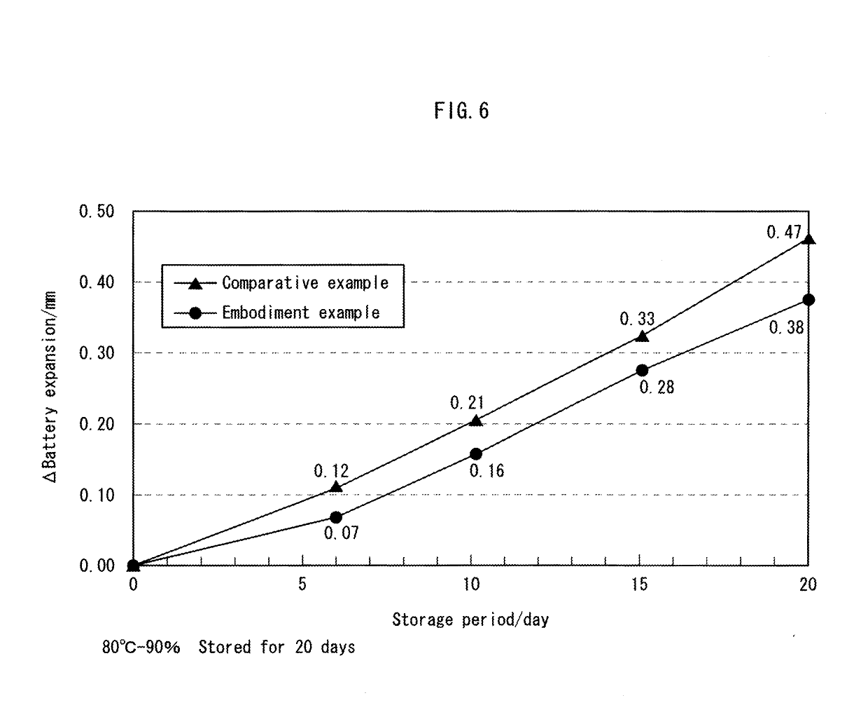

Five samples were prepared that were identical to the laminate-cased battery 1 according to the embodiment example. Also, five samples were prepared that were identical to the laminate-cased battery according to the comparative example. These samples were stored for 20 days under the condition where the temperature was 80° C. and the humidity was 90%, and expansion of each of the samples was then measured. The measurement result is shown in FIG. 6. Each data piece shown in FIG. 6 is an average of the samples in each of the embodiment example and the comparative example.

As shown in FIG. 6, every data piece shows that the laminate-cased battery 1 according to the embodiment example is better than the laminate-cased battery according to the comparative example, with regards to the battery expansion under the high temperature and high humidity storage condition. Specifically, on the 20^{th} day of the storage period, the laminate-cased battery according to the comparative example expanded by 0.47 mm, whereas the laminate-cased battery 1 according to the embodiment example expanded by merely 0.38 mm. In percentage, expansion of the laminate-cased battery 1 is suppressed by greater than 20%.

### (3) Effect on Peel Strength

Five samples identical to the laminate-cased battery 1 according to the embodiment example and five samples identical to the laminate-cased battery according to the comparative example were prepared to measure the peel strength. Specifically, the measurement was conducted on the peel strength of the laminate case 20 in the areas that the positive tab 14 and the negative tab 15 cross, and on the peel strength of the laminate case 920 in the areas that the positive tab and the negative tab 915 cross.

The peel strength was measured as follows. After being stored under the high temperature and the high humidity condition, the battery was disassembled. Then, the positive tab, the negative tab, and the sealed portion of the laminate case were separated from the rest of the battery. With the tabs being fixed, the laminate sheet was pinched and pulled at a speed of 5 mm/min in a 180° direction with respect to a main surface of the laminate sheet. The peel strength was measured when the laminate sheet was peeled from the tabs.

Table 2 shows a result showing the lowest strength of each battery, among results obtained after measurement of five samples for each battery.

TABLE 2

Peel strength [N/mm]

| | Positive tab | Negative tab |
|---|---|---|
| Comparative example | 5.6 | 6.3 |
| Embodiment example | 5.7 | 7.5 |

As shown in Table 2, regarding the peel strength in the area corresponding to the positive tab, no significant difference was observed between the embodiment example and the comparative example. In other words, regarding the positive tab which is thinner than the negative tab, the structure as shown in FIG. 3 does not contribute much to the peel strength.

Regarding the peel strength in the area corresponding to the negative tab, the laminate-cased battery according to the comparative example has a value of 6.3 N/mm. On the other hand, the laminate-cased battery 1 according to the embodiment example has a value of 7.5 N/mm, which is better than the value in the comparative example by greater than 19%. According to the result above, it is considered that the following advantage was obtained by employing the structure as shown in FIG. 3 in the area corresponding to the negative tab, which is thicker than the positive tab. That is, with the structure, the stress of the tab during a sealing process was alleviated, resulting in the peel strength being improved.

### (4) Study

Table 3 shows the results of the evaluations in (2) and (3) above.

TABLE 3

| | | | Effect in |
|---|---|---|---|
| | Comparative | Embodiment | embodiment |
| Evaluation item | example | example | example |
| (1) Effect under | +0.47 [mm] | +0.38 [mm] | Effective |
| high temperature | (20^{th} day) | (20^{th} day) | |
| and high humidity | | | |
| storage condition | | | |
| (2) Effect on peel | Negative tab: 6.3 | Negative tab: 7.5 | Effective |
| strength | [N/mm] | [N/mm] | |

As shown in FIG. 3, the laminate-cased battery 1 according to the embodiment example has better results than the laminate-cased battery according to the comparative example, with respect to both of the evaluation items (1) and (2), i.e., the effect under the high temperature and high humidity storage condition and the effect on the peel strength. Regarding the effect on the peel strength, the strength corresponding to the negative tab 15 was particularly better than the strength measured in the comparative example by 19%.

The above results show that the laminate-cased battery 1 according to the embodiment example which employs the structure as shown in FIG. 3 has high sealing reliability, and ensures excellent quality.

### Modification 1

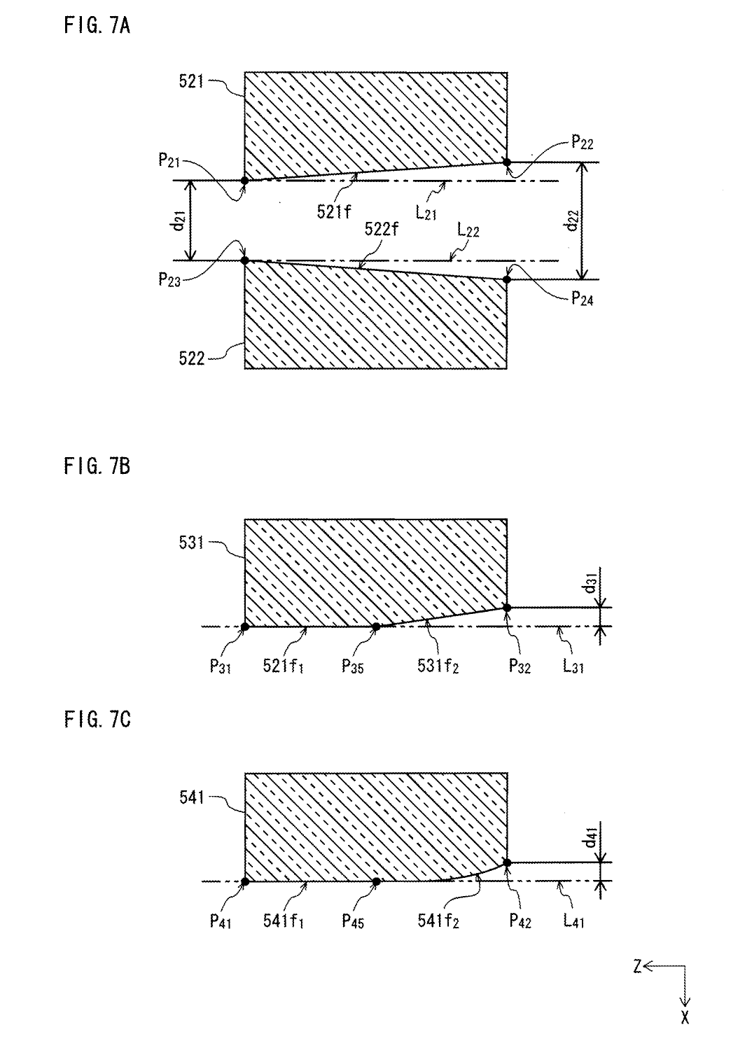

The following describes the structure of a laminate-cased battery according to Modification 1, with reference to FIG. 7A. FIG. 7A shows parts of laminate forming dies 521 and 522. Specifically, FIG. 7A only shows parts of the laminate forming dies 521 and 522 that correspond to the area of the sealed portion of the laminate case that the negative tab crosses.

The laminate forming dies 521 and 522 are used to form the laminate-cased battery according to Modification 1. As shown in FIG. 7A, the laminate forming die 521 positioned upward in the X-axis direction has a surface 521f which is inclined in the same manner as the surface 501f of the laminate forming die 501 according to the above embodiment. Therefore, a point P₂₂ of the laminate forming die 521 is positioned more upward than a point P₂₁ thereof in the X-axis direction.

According to the present modification, the laminate forming die 522 positioned downward in the X-axis direction has a surface 522f which is also inclined in the area of the sealed portion of the laminate case that the negative tab crosses. Therefore, a point P₂₄ of the laminate forming die 522 is positioned more downward than a point P₂₃ in the X-axis direction.

When the outer edges of the laminate case are sealed with use of the laminate forming dies 521 and 522 as described above, a distance d₂₂ between the outer edges is wider than a distance d₂₁. Specifically, the distance d₂₂ is a distance at a portion, in the area that the negative tab crosses, located closer to the root portion of the negative tab in the extending direction thereof, and the distance d₂₁ is a distance at a portion located closer to the tip portion of the negative tab. The taper angle between the surface 521f of the laminate forming die 521 and the surface 522f of the laminate forming die 522 is from 1° to 3° inclusive. In other words, the sum of (i) the inclination angle of the surface 521f with respect to a virtual line L₂₁ parallel to the Z axis and (ii) the inclination angle of the surface 522f with respect to a virtual line L₂₂ parallel to the Z axis is from 1° to 3° inclusive.

The laminate-cased battery according to the present modification, which is formed with use of the laminate forming dies 521 and 522, achieves the same advantageous effects as the laminate-cased battery 1 according to the above embodiment.

### Modification 2

The following describes the structure of a laminate-cased battery according to Modification 2, with reference to FIG. 7B. FIG. 7B shows a part of a laminate forming die 531. Specifically, FIG. 7B only shows a part of the laminate forming die 531 that corresponds to the area of the sealed portion of the laminate case that the negative tab crosses. As for the corresponding laminate forming die positioned downward in the X-axis direction, the laminate forming die 501 according to the above embodiment can be used as is.

As shown in FIG. 7B, the laminate forming die 531 according to the present modification has a surface 531f₁ which is a horizontal surface (horizontal to the Z axis) and a surface 531f₂ which is inclined. The surface 531f₁ extends from a point P₃₁ to a midpoint P₃₅, and the point P₃₁ is closer to the tip portion of the negative tab in the extending direction thereof. The surface 531f₂ extends from the midpoint P₃₅ to a point P₃₂ which is closer to the root portion of the negative tab in the extending direction thereof.

A distance d₃₁ from a virtual line L₃₁ parallel to the Z axis to the point P₃₂ is set such that an angle between the virtual line L₃₁ and a virtual line connecting the point P₃₁ and the point P₃₂ is from 1° to 3° inclusive.

The laminate-cased battery according to the present modification, which is formed with use of the laminate forming die 531, achieves the same advantageous effects as the laminate-cased battery 1 according to the above embodiment.

### Modification 3

The following describes the structure of a laminate-cased battery according to Modification 3, with reference to FIG. 7C. FIG. 7C shows a part of a laminate forming die 541. Specifically, FIG. 7B only shows a part of the laminate forming die 541 that corresponds to the area of the sealed portion of the laminate case that the negative tab crosses. Also, as for the corresponding laminate forming die positioned downward in the X-axis direction, the laminate forming die 501 according to the above embodiment can be used as is, similarly to the Modification 2 above.

As shown in FIG. 7C, the laminate forming die 541 according to the present modification has a surface 541f₁ which is a horizontal surface (horizontal to the Z axis) and a surface 541f₂ which has a curvature. The surface 541f₁ extends from a point P₄₁ to a midpoint P₄₅, and the point P₄₁ is closer to the tip portion of the negative tab in the extending direction thereof. The surface 541f₂ extends from the midpoint P₄₅ to a point P₄₂ which is closer to the root portion of the negative tab in the extending direction thereof.

A distance d₄₁ from a virtual line L₄₁ parallel to the Z axis to the point P₄₂ is set such that an angle between the virtual line L₄₁ and a virtual line connecting the point P₄₁ and the point P₄₂ is from 1° to 3° inclusive, similarly to the Modification 2 above.

The laminate-cased battery according to the present modification, which is formed with use of the laminate forming die 541, achieves the same advantageous effects as the laminate-cased battery 1 according to the above embodiment. Also, since an angle is not formed at a point P₄₅ at which the surface 541f₁ and the surface 541f₂ intersect, the concentration of stress is less likely to occur during the sealing process.

### Others

According to the Embodiment and the Modifications 1 to 3 above, the laminate-cased battery 1 has the structure where the positive tab 14 and the negative tab 15 extend outwardly across the sealed portion 20c of the laminate case 20. However, this is merely an example, and the positive tab 14 and the negative tab 15 do not always need to extend across the sealed portion 20c together. For example, it is possible to employ a structure where either the positive tab 14 or the negative tab 15 extends across one of the other sealed portions 20b and 20d. In this case, the structure according to any of the Embodiment and the Modifications 1 to 3 above may be applied to the area of the sealed portion that the negative tab 15 crosses so as to obtain the same advantageous effects as described above.

Also, according to the Embodiment and the Modifications 1 to 3 above, at least one of the surfaces of the laminate case 20 is inclined or curved in the area of the sealed portion that the negative tab 15 crosses. However, this structure is also applicable to the area of the sealed portion that the positive tab 14 crosses. If the sealing properties or the like are empirically determined to be problematic in the area of the sealed portion that the positive tab 14 crosses, the aforementioned structure may be applied to the area that the positive tab 14 crosses so as to obtain the same advantageous effects as described above.

Also, according to the Embodiment above, the tab resin 31 is provided between the positive tab 14 and the laminate case 20, and the tab resin 32 is provided between the negative tab 15 and the laminate case 20. However, the tab resin 31 and the tab resin 32 do not always need to be provided. The tab resin 31 and the tab resin 32 may be omitted to reduce cost as long as the omission does not affect the sealing properties and the like.

The laminate forming dies may be any appropriate combination of the laminate forming dies 501 and 502 according to the Embodiment above, the laminate forming dies 521 and 522 according to the Modification 1 above, the laminate forming die 531 according to the Modification 2 above, and the laminate forming die 541 according to the Modification 3 above. For example, the laminate forming die 502 or the laminate forming die 521 may be employed as an upper die, and a laminate forming die that is a mirror image of the laminate forming die 531 or the laminate forming die 541 about a horizontal axis may be employed as a lower die.

According to the Embodiment above, the laminate-cased battery 1 has a three-side sealed structure. However, it is not limited to such and the laminate-cased battery according to the present invention may have a four-side sealed structure.

Also, according to the Embodiment above, the metal laminate sheet forming the laminate case has a structure where the metal layer is sandwiched by the inner resin layer and the outer resin layer in the thickness direction of the metal layer. However, the metal laminate sheet does not need to include the outer resin layer, and may be composed of the metal layer and the inner resin layer covering the inner main surface of the metal layer.

### Industrial Applicability

The present invention is applicable to a battery of a mobile apparatus such as a mobile telephone, and is useful in realizing a highly-reliable laminate-cased battery.

### Reference Signs List

1 laminate-cased battery
10 electrode assembly
11 positive plate
12 negative plate
13 separator
14 positive tab
15 negative tab
20 laminate case
21 metal layer
22 inner resin layer
23 outer resin layer
31, 32 tab resin
200, 201 metal laminate sheet
501, 502, 521, 522, 531, and 541 laminate forming die

1. A laminate-cased battery comprising:
an electrode assembly including a positive plate and a negative plate;
a laminate case housing the electrode assembly therein, the laminate case being made of a metal laminate sheet including a metal layer and a resin layer that are laminated on each other, and having a sealed portion which is a sealed edge of the metal laminate sheet;
a positive tab made of a conductive material and connected to the positive plate, the positive tab crossing the sealed portion and partially extending outwardly from the laminate case; and
a negative tab made of a conductive material and connected to the negative plate, the negative tab crossing the sealed portion and partially extending outwardly from the laminate case, wherein
in at least one of crossing areas of the sealed portion that the positive tab and the negative tab cross, a distance between outer surfaces of the laminate case in a thickness direction of the corresponding tab, which is one of the positive tab and the negative tab, is smaller in a first portion of the crossing area than in a second portion thereof, the first portion being located closer to a tip portion of the corresponding tab in an extending direction thereof, and the second portion being located closer to a root portion of the corresponding tab in the extending direction.

2. The laminate-cased battery of claim 1 wherein
in the at least one of the crossing areas, the distance between the outer surfaces of the laminate case gradually decreases from the second portion to the first portion.

3. The laminate-cased battery of claim 2 wherein
in the at least one of the crossing areas, a taper angle formed between the outer surfaces of the laminate case as the distance between the outer surfaces gradually decreases is from 1° to 3° inclusive.

4. The laminate-cased battery of claim 1 wherein
the negative tab is thicker than the positive tab, and
the distance between the outer surfaces of the laminate case is smaller in the first portion than in the second portion of the crossing area that the negative tab crosses.

5. The laminate-cased battery of claim 1 wherein
the resin layer of the laminate case is disposed inward with respect to the metal layer, and
in the at least one of the crossing areas where the distance between the outer surfaces of the laminate case is smaller in the first portion than in the second portion, a compression ratio of the resin layer is lower in the second portion than in the first portion.

6. The laminate-cased battery of claim 1 wherein
in the crossing areas of the sealed portion that the positive tab and the negative tab cross, a resin sheet is provided between the positive tab and the laminate case and between the negative tab and the laminate case, the resin sheet being made of a resin material different from a resin material of the resin layer, and
in the at least one of the crossing areas where the distance between the outer surfaces of the laminate case is smaller in the first portion than in the second portion, a compression ratio of the resin sheet is lower in the second portion than in the first portion.

7. The laminate-cased battery of claim 1 wherein
the resin layer of the laminate case is disposed inward with respect to the metal layer, and
in the crossing areas of the sealed portion that the positive tab and the negative tab cross, both surfaces of each of the positive tab and the negative tab in a thickness direction thereof are densely covered with the resin layer.
